(19) United States
(12) Patent Application Publication
(10) Pub. No.: US 2010/0132195 A1
(43) Pub. Date: Jun. 3, 2010

(54) MICRO-REFORMER AND MANUFACTURING METHOD THEREOF

(75) Inventors: Sang Jin Kim, Suwon (KR); Ro Woon Lee, Seoul (KR)

Correspondence Address: MCDERMOTT WILL & EMERY LLP, 600 13TH STREET, N.W., WASHINGTON, DC, 20005-3096, US

(73) Assignee: Samsung Electro-Mechanics Co., Ltd., Gyunggi-do (KR)

(21) Appl. No.: 12/697,833

(22) Filed: Feb. 1, 2010

Related U.S. Application Data
(62) Division of application No. 11/448,833, filed on Jun. 8, 2006.

(30) Foreign Application Priority Data
Jun. 9, 2005 (KR) 10-2005-0049176

(51) Int. Cl. H01M 8/06; B21D 51/16

(52) U.S. Cl. 29/890

(57) ABSTRACT

The invention relates to a micro-reformer using a liquid fuel such as methanol and a manufacturing method thereof. The reformer for producing hydrogen gas from the liquid fuel includes a first substrate having a first grooved path and a catalyst layer, and a second substrate having a second grooved path and a catalyst layer, the first and second grooved paths are overlapped on each other forming a micro-channel. The micro-channel has a fuel inlet, a hydrogen outlet, a reforming section, and a carbon monoxide removing section with heating means disposed therein. Although reduced in size, the reformer allows increased hydrogen emission amount due to increased area of the inner path, and is operable with low power due to effective disposition of a heater. This allows manufacturing at low costs and mass-production via semiconductor process.

### CLAIM OF PRIORITY

This application claims the benefit of Korean Patent Application No. 2005-49176 filed on Jun. 9, 2005, in the Korean Intellectual Property Office, the disclosure of which is incorporated herein by reference.

### BACKGROUND OF THE INVENTION

1. Field of the Invention

The present invention relates to a micro-reformer fox a micro fuel cell using a liquid fuel like methanol and a manufacturing method thereof. More particularly, the invention relates to a micro-reformer increased in the hydrogen emission amount per time with increased area of an inner flow path, operable with low power due to efficient disposition of a heater, and manufactured by a semiconductor process, allowing mass production at low costs, and a manufacturing method thereof.

2. Description of the Related Art

In general, a fuel cell includes various types such as a polymer electrolyte fuel cell, a direct methanol fuel cell, a molten carbonate fuel cell, a solid oxide fuel cell, a phosphoric acid fuel cell, and an alkaline fuel cell. Among these, the most extensively used portable micro fuel cells include the Direct Methanol Fuel Cell (DMFC) and the Polymer Electrolyte Membrane Fuel Cell (PEMFC). The DMFC and PEMFC adopt the same components and material but the former uses methanol and the latter uses hydrogen gas, respectively, and thus have different capabilities and fuel supply systems that are often compared with each other.

The DMFC uses hydrocarbon liquid fuels like methanol and ethanol, thus has advantage in storage, stability, and miniaturization compared with the PEMFC. But its energy density level is lower than that of the PEMFC which uses hydrogen gas. In order to overcome such a drawback, there have been active researches recently on the PEMFC adopting a reformer for producing hydrogen from a liquid fuel.

Miniaturization and output density are the most important factors in developing a portable fuel cell. The PEMFC as a fuel cell applied to a portable device has high output density per capacity, and thus directly related to the performance of the portable device. And the PEMFC requires a reformer for producing gas from a liquid fuel. However, reforming fuel consumes high level of power, which has been pointed out as a problem. To date, there has not been developed a micro-reformer producing high output with low power, and thus recently, there have been active researches to develop a micro-reformer to meet such needs.

FIG. 1a illustrates a conventional micro-reformer 300 using methanol. Such a conventional reformer 300 uses a fuel gas and is capable of mitigating the crossover of hydrocarbon fuel exhibited in the DMFC. This conventional reformer 300 has a catalyst membrane formed in flow paths that are stacked in parallel to pass more low-density fuel gas from methanol, thereby enhancing generation of hydrogen ions and electrons while decreasing the density of methanol reaching the electrolyte membrane. However, such a conventional reformer 300 does not include a heater in the flow path, thus consumes a high level of power for reforming the liquid fuel.

FIG. 1b illustrates another conventional micro-reformer 320 different from the foregoing reformer. In this, conventional method, however, in the process of liquid fuel being reformed while passing through a catalyst layer 324 in a flow path 322, heat is transferred from heaters 326 through a substrate 328 to the catalyst layer 324. Thus, the structure does not allow good heat efficiency and consumes a high level of power for reforming a liquid fuel.

FIG. 2a illustrates yet another conventional reformer 340 suggested in Japanese Patent Application Publication No. 2003-45459. This reformer 340 of the conventional technology provides a structure including a first substrate as a planar cover, a second substrate 344 having a flow path groove 344a and a catalyst layer 344b on one side thereof, and a third substrate 346 having an insulated cavity 346b with a polished surface 346a therein. The reformer 340 also includes a micro-passage formed by the flow path groove 344a of the second substrate 344, having a catalyst layer 344b for producing hydrogen gas and carbon dioxide from methanol and water, and a thin-membrane heater 348 disposed under the catalyst layer 344b along the micro-passage.

This conventional method is increased in heat efficiency with the heater as heating means inside the flow path, but the structure is complicated to manufacture. Also, the catalyst layer 344b is limited to some portion, resulting in low reforming efficiency.

FIG. 2b illustrates another conventional reformer 360 suggested in U.S. Publication No. 2003/0190508, which includes a first substrate having a grooved path 362a and a catalyst layer 362b thereon, a planar second substrate 364 attached to the first substrate 362, a reactive flow path formed by the groove 362a of the first substrate, having a catalyst layer 362b therein for producing hydrogen gas and carbon dioxide from methanol and water, and a thin-membrane heater 366 formed on the second substrate 364 to block the bottom of the reactive flow path, being supplied with power through a lead wire.

In this conventional method, however, the flow path and the catalyst layer 362b are concentrated in one substrate 362 only so that the flow path and the catalyst layer are not large enough, yielding a mediocre level of output capabilities per capacity.

Therefore, there has been a demand for micro-reformer having heating means inside a flow path for high heat efficiency and a deep and wide flow path for high reforming efficiency per capacity.

### SUMMARY OF THE INVENTION

The present invention has been made to solve the foregoing problems of the prior art and therefore an object of certain embodiments of the present invention is to provide a micro-reformer in which a reforming section and a carbon monoxide removing section are disposed alongside while a heater is efficiently disposed in a micro-channel to enhance heat efficiency, allowing excellent reforming effect, and a manufacturing method thereof.

Another object of certain embodiments of the invention is to provide a micro-reformer increased in the area of a micro-channel by disposing a reforming section and a carbon monoxide removing section alongside, allowing excellent reforming efficiency per capacity, and a manufacturing method thereof.

According to an aspect of the invention for realizing the object, there is provided a micro-reformer for producing hydrogen gas from a liquid fuel including: a first substrate having a first grooved path formed on one side thereof and a catalyst layer formed on an inner surface of the first grooved path; a second substrate having a second grooved path and a catalyst layer formed on an inner surface of the second grooved path corresponding to the first grooved path and the catalyst layer of the first substrate, the first and second grooved paths are overlapped on each other forming a micro-channel; the micro-channel having a fuel inlet in one end thereof and a hydrogen outlet in the other end thereof, and having a reforming section in one portion thereof and a carbon monoxide removing section in the other portion thereof; and heating means having a heater disposed in the micro-channel.

According to another aspect of the invention for realizing the object, there is provided a manufacturing method of a micro-reformer for producing hydrogen gas from a liquid fuel including steps of:

providing a first substrate having a first grooved path on one side thereof and a catalyst layer formed in an inner surface of the first grooved path;

providing a second substrate having a second grooved path and a catalyst layer corresponding to the first grooved path and the catalyst layer and a heating means; and

bonding the first and second substrates such that the first and second grooved paths are overlapped on, each other to form a micro-channel, a reforming section adjacent to a fuel inlet, a carbon monoxide removing section downstream of the fuel inlet, and a hydrogen outlet downstream of the carbon monoxide removing section.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a micro-reformer according to the prior art, in which (a) is an exploded perspective view of a stacked structure, and (b) is a heater-detachable structure;

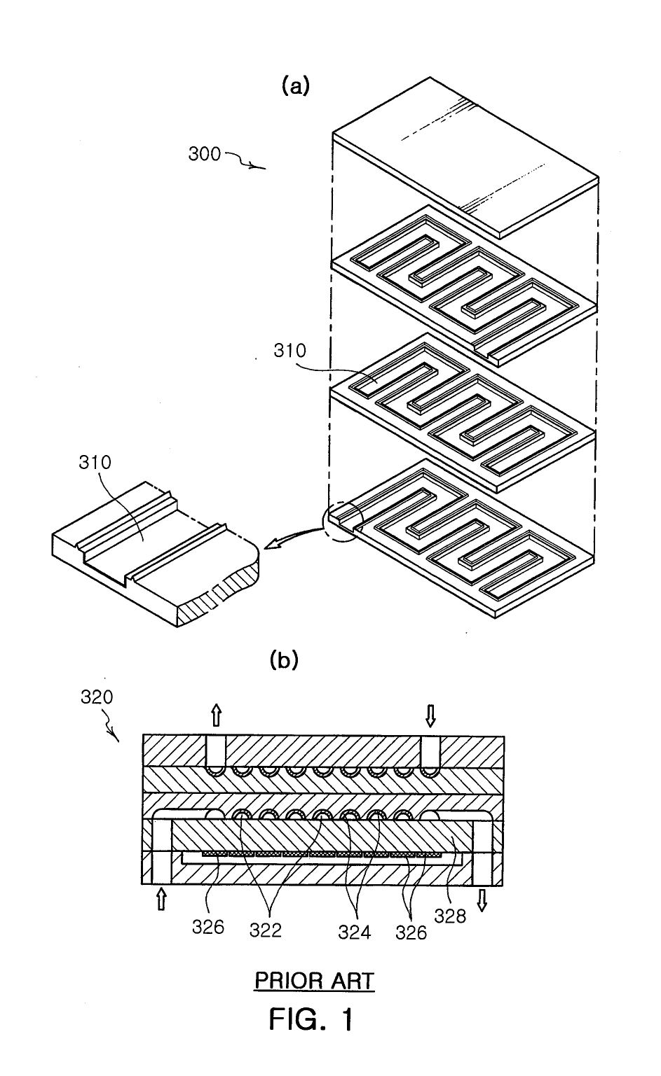

FIG. 2 is a block diagram illustrating another micro-reformer according to the prior art, in which, (a) is a sectional view of a structure with a flow path in one substrate, and (b) is a sectional view of another structure with a flow path in one substrate;

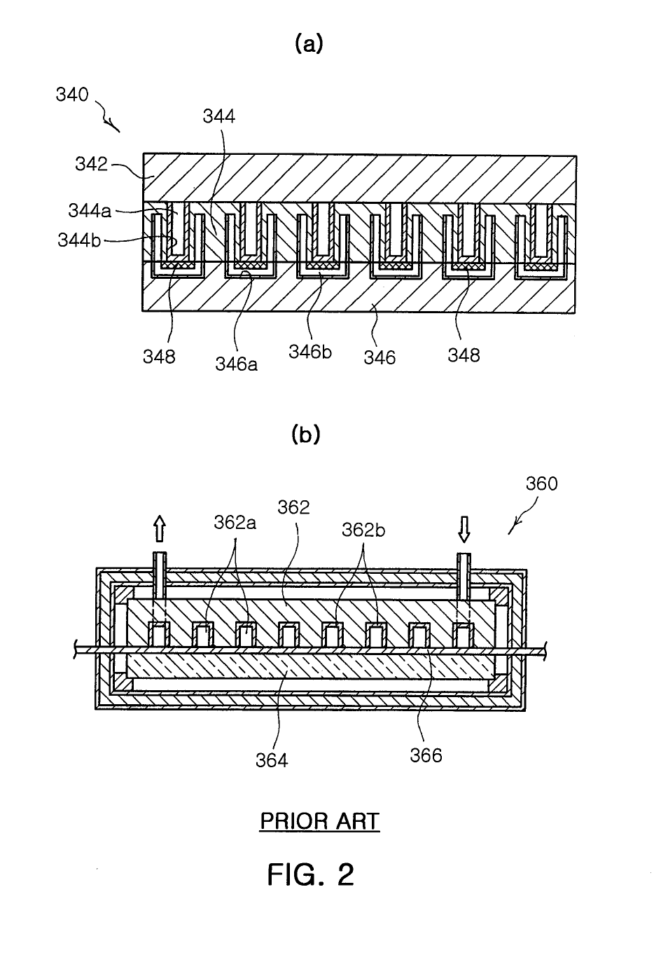

FIG. 3 is an exploded perspective view illustrating a micro-reformer according to the present invention;

FIG. 4 is a perspective view illustrating the micro-reformer-according to the present invention, in an assembled state;

FIG. 5 is a partial perspective view illustrating a micro-channel of the micro-reformer according to the present invention;

FIGS. 6a and 6b are views illustrating the manufacturing steps of the micro-reformer according to the present invention, in which FIG. 6a illustrates the manufacturing steps of a first substrate with a silicon wafer, and FIG. 6b illustrates the manufacturing steps of a first substrate with PDMS;

FIG. 7 is a view illustrating the manufacturing steps of a second substrate of the micro-reformer according to the present invention; and

FIG. 8 is a view illustrating the manufacturing steps of the micro-reformer according to the present invention.

### DETAILED DESCRIPTION OF THE PREFERRED EMBODIMENT

Preferred embodiments of the present invention will now be described in detail with reference to the accompanying drawings.

The micro-reformer 1 according to the present invention is manufactured in a miniaturized structure in which a reforming section 10 and a carbon monoxide removing section 30 for removing CO are integrated to produce hydrogen gas from a liquid fuel.

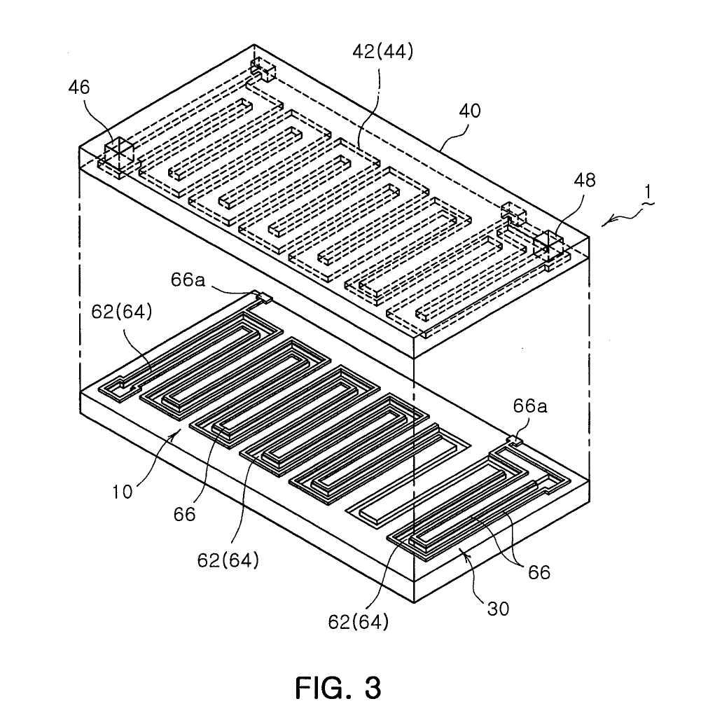

As shown in FIGS. 3 to 5, the micro-reformer 1 according to the present invention includes a first substrate 40 having a first grooved path 42 formed on one side thereof and a catalyst layer 44 formed on an inner surface of the first grooved path 42.

The first substrate 40 has a grooved path 42 on one side thereof, and is preferably made of a silicon Si wafer. The grooved path 42 is formed via a semiconductor manufacturing process. The grooved path 42 has a fuel inlet 46 in one end thereof, and a hydrogen outlet 48 in the other end thereof. The grooved path 42 has a catalyst layer 44 composed of CuO/ZnO/Al₂O₃ coated on a portion corresponding to the reforming section 10, and a catalyst layer 44 composed of Pt/Al₂O₃ coated on a portion corresponding to the carbon monoxide removing section 30 downstream of the reforming section 10.

In addition, the first substrate 40 may be made of poly-dimethysiloxane (PDMS) instead of a silicon wafer in order to have an increased catalyst contact area with minimal electric loss from heat discharge.

The PDMS is commercially available from Dow Corning Corporation, U.S. under the brand name of “SYLGARD® 184 Silicone Elastomer,” which is chemically stable and processed in relatively a short period at low costs. In addition, an excellent heat-blocking effect is exhibited in the portion heated by heating means 66 with the PDMS. The PDMS also has machining advantages such that it does not require additional packaging, allowing a simple process, and can be directly connected to an electrode pad.

Moreover, the inner surface area of the groove path 42 can be further increased with the increased depth of the grooved path 42, allowing free adjustment of hydrogen amount produced and significantly decreasing manufacturing costs and time.

In addition, the preset invention includes a second substrate having a second grooved path 62 and a catalyst layer 64 corresponding to the first groove path 42 and the catalyst layer 44 of the first substrate.

The second substrate 60 has the second grooved path 62 on one side thereof to overlap with the first groove path 42 of the first substrate 40. Identical to the first substrate 40, the second grooved path 62 of the second substrate 60 has a catalyst layer 64 composed of CuO/ZnO/Al₂O₃ coated on a portion corresponding to the reforming section 10, and a catalyst layer 64 composed of Pt/Al₂O₃ coated on a portion corresponding to the carbon monoxide removing section 30 downstream of the reforming section 10.

In addition, the second grooved path 62 of the second substrate 60 is narrower in width than the first groove path 42 of the first substrate 40, and has heating means disposed on opposed peripheries across the second grooved path 62. The heating means 66 are a heat source providing heat in a high temperature ranging from 120° C. to 300° C.

That is, the heating means 66 are preferably composed of hot wires of electrically resistive material. The heating means have separate hot wires disposed respectively in the reforming section 10 and the carbon monoxide removing section 30, such that a high temperature of about 250 to 300° C. is maintained in the reforming section 10 and a temperature of about 150° C. is maintained in the carbon monoxide removing section 30.

The heating means 66 have power source pads 66a provided to the reforming section 10 and the carbon monoxide removing section 30, respectively, to supply power to the hot wires.

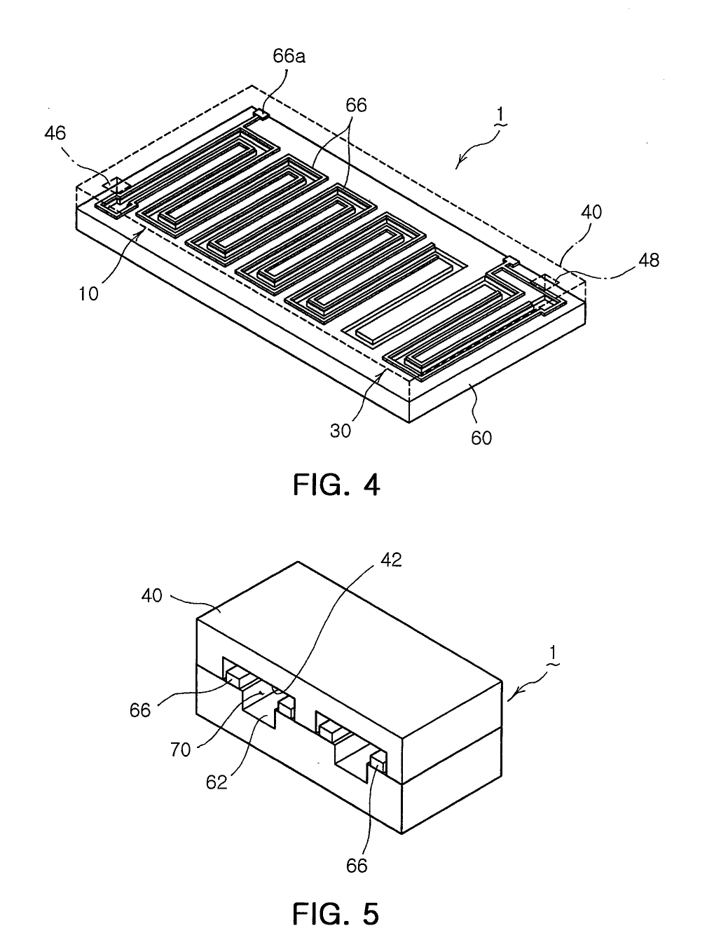

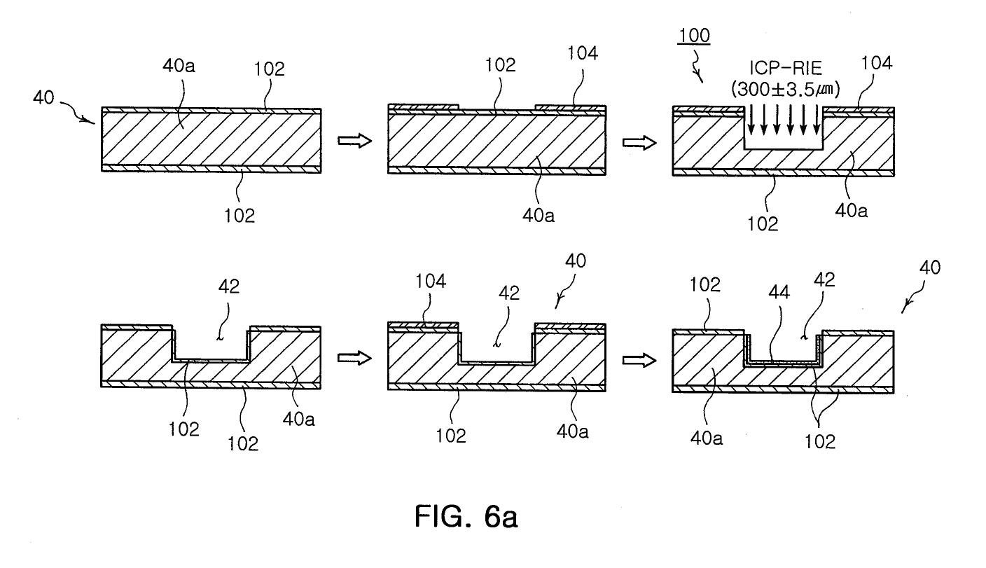

The first substrate 40 and the second substrate 60 are bonded or bound together to form one body with the first and second grooved paths 42 and 62 overlapped on each other. The first and second grooved paths 42 and 62 cooperate with each other to form a continuous micro-channel 70 as shown in FIGS. 4 and 5.

That is, the micro-channel 70 is formed by the first and second grooved paths 42 and 62 overlapped on each other, and has a fuel inlet 46 in one end thereof and a hydrogen outlet 48 in the other end thereof with an inner flow path formed between the fuel inlet 46 and the hydrogen outlet 48.

The fuel inlet 46 and the hydrogen outlet 48 are preferably formed on the first substrate 40.

The heating means 66 have three surfaces, i.e., the upper and side surfaces exposed inside the micro-channel 70 except a bottom surface supported by the second substrate 60. This structure allows effective heating of the inner space of the micro-channel 70 formed by the first and second grooves 42 and 62 of the first substrate 40 and the second substrate 60 when heat is applied from the heating means 66.

In addition, the heating means 66 have multiple hot wires disposed in the micro-channel such that the heat is applied to the reforming section 10 at a temperature ranging from 250 to 300° C., and to the carbon monoxide removing section 30 at a temperature of 150° C., respectively.

A manufacturing method of a micro-reformer according to the present invention will now be explained hereunder.

The first step to manufacturing the micro-reformer 1 according to the present invention is a process 100 of providing a first substrate 40 having a first grooved path 42 formed on one side thereof and a catalyst layer 44 formed on an inner surface of the first grooved path 42.

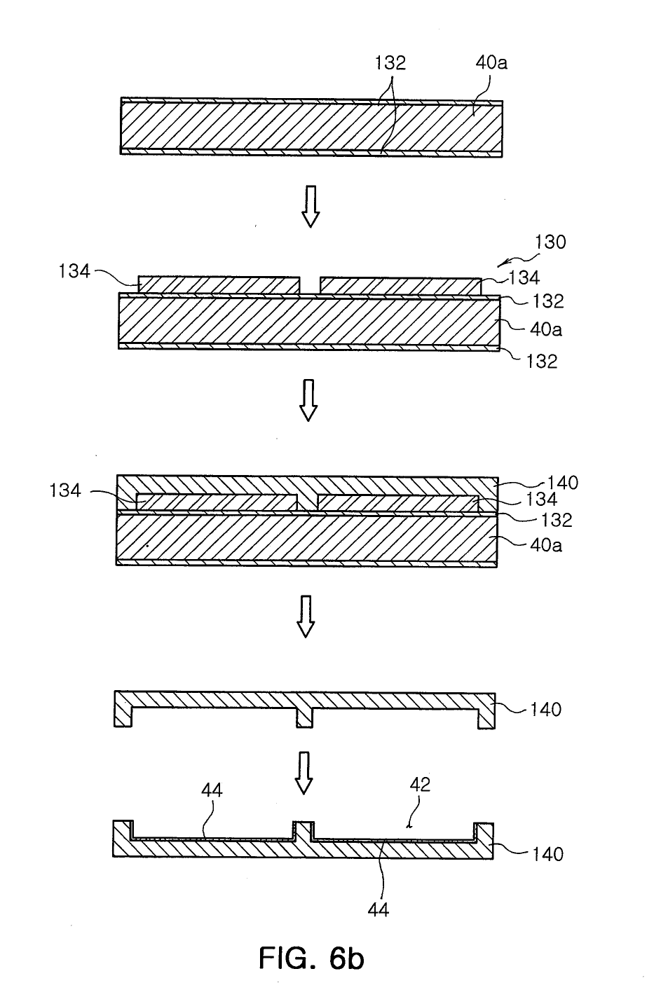

This process 100 of providing the first substrate 40 includes, as shown in FIG. 6a, depositing a SiO₂ layer 102 on a Si wafer 40a having both sides polished.

Then, a photo-resist (PR) 104 is coated on the Si wafer 40a, and photolithography is performed with a first mask to form a grooved path.

Then, the Si wafer is etched using Inductively Coupled Plasma-Reactive Ion Etching (ICP-RIE) to form, the grooved path 42, and the photo-resist (PR) 104 is removed.

Then, the SiO₂ layer 102 is deposited on an inner surface of the grooved path 42, and another photo-resist (PR) 104 is coated again to coat a catalyst layer 44 later. Then, photolithography is performed on an inner surface of the grooved path 42 with a second mask. Then, a catalyst layer 44 material is coated on an inner surface of the grooved path 42 and the photo-resist PR 104 is removed.

Thereby, the catalyst layer 44 is formed on an inner surface of the grooved path 42 of the first substrate 40.

Alternatively, the first substrate 40 can be formed with PDMS through the steps 130 illustrated in FIG. 6b.

First, SiO₂ is deposited on a Si wafer 40a via thermal oxidation to form a SiO₂ layer 132.

Next, a photo-resist PR 134 is formed on one side of the Si wafer 40a by spin coating, and photolithography is performed except on a portion corresponding to the grooved path 42.

Then, PDMS 140 available from Dow corning is poured on the Si wafer 40a and cured for 1 hour at about 60° C., and then the PDMS layer 140 is separated from the Si wafer 40a to form the first substrate 40. The PDMS layer 140 is surface-treated via arc, discharge to allow depositing catalyst material on an inner surface of the grooved path 42. Then the catalyst layer 44 is coated on an inner surface of the grooved path 42.

The above steps allow forming the first substrate 40 with PDMS 140 with the catalyst, layer 44 formed on an inner surface of the grooved path 42 in a preferred way.

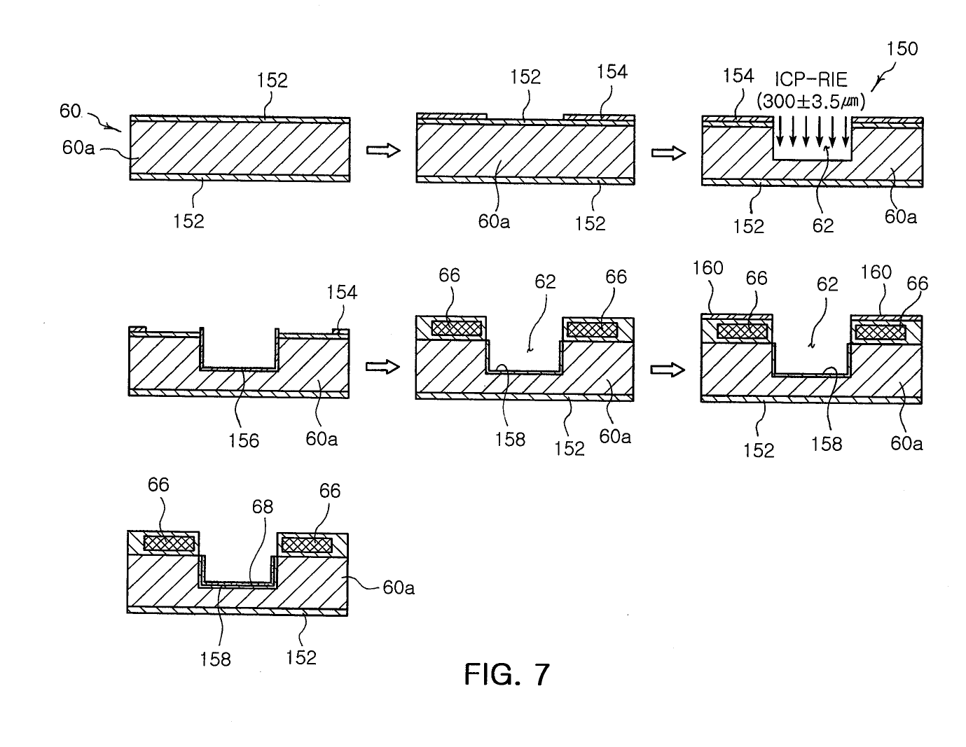

FIG. 7 illustrates the steps for providing the second substrate 60 having a second grooved path 62 corresponding to the first grooved path 42 of the first substrate 40, a catalyst layer 64 and heating means 66.

In this process 150, a SiO₂ layer 152 is deposited on a Si wafer 60a having both sides polished. Then, a photo-resist (PR) 154 is coated on the Si wafer 60a, and then photolithography is performed with a first mask to form a grooved path.

Then, the Si wafer 60a is etched using ICP-RIE to form the grooved path 62, and then another photo-resist (PR) 156 is coated on an inner surface of the grooved path 62.

Next; in order to dispose a heater of the heating means 66, photolithography is performed using a second mask on opposed peripheries across the grooved path 62, and then the SiO₂ layer 152 is exposed.

Then, Pt is deposited on exposed surface areas of the SiO₂ layer 152, opposed to each other across the grooved path 62, thereby forming Pt electrodes, which are the heating means 66. Then, a SiO₂ layer 158 is deposited on the electrode surface of the heating means 66 and on an inner surface of the second grooved path 62 via passivation.

Next, a photo-resist PR 160 is coated on the deposited SiO₂ layer 158, and in order to coat the catalyst layer 68 on the inner surface of the grooved path 62, photolithography is performed on an inner surface of the second grooved path 62 with a third mask. Then, the catalyst layer 68 material is coated on the grooved path 62, and the photo-resist PR 160 is removed from the surface of the heating means 66.

The above steps 150 allow forming the grooved path 62 on the second substrate 60 on one surface thereof with a catalyst layer 68 formed on an inner surface of the second grooved path 62 in a preferred way, and also integrally forming the electrodes of the heating means 66 made of electrically resistive hot wires on the opposed peripheries across the second grooved path 62.

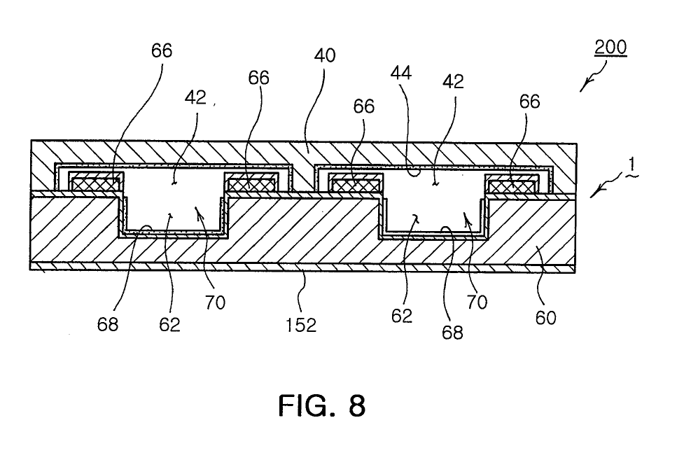

In the above process, the first substrate 40 and the second substrate 60 are manufactured separately, and then as shown in FIG. 8, are bonded or bound together in the following process 200 to complete the micro-reformer according to the present invention.

In the micro-reformer 1 manufactured through the above steps, as shown in FIG. 8, the first and second grooved paths 42 and 62 are overlapped on each other to form a micro-channel 70 which has a reforming section 10 formed adjacent to a fuel inlet 46 in one portion thereof, a carbon monoxide removing section 30 formed downstream of the reforming section 10, and a hydrogen outlet 48 formed downstream of the carbon monoxide removing section 30.

Therefore, when the micro-reformer 1 according to the present invention is injected with a liquid fuel through the fuel inlet 46 to the reforming section 10, the catalyst layer 44 composed of CuO/ZnO/Al₂O₃ coated on the reforming section 10, maintained at a high temperature ranging about 250 to 300° C. reforms the liquid fuel into hydrogen gas and carbon monoxide.

The hydrogen gas and the carbon monoxide produced from the liquid fuel as described above move downstream to the carbon monoxide removing section 30. In the carbon monoxide removing section 30, the catalyst layer 44 composed of Pt/Al₂O₃ is heated at about 150° C. to convert the carbon monoxide to carbon dioxide, removing the carbon monoxide.

Then, the hydrogen and some portion of the carbon dioxide that passed through the reforming section 10 and the carbon monoxide removing section 30 exit through the hydrogen outlet 48, and are provided to a fuel cell stack to generate electricity.

According to the present invention as described above, the grooved paths are formed on both of the first and second substrates, and overlapped on each other to form the micro-channel, increasing the areas of the micro-channel and the catalyst layer and hydrogen emission amount per time, thereby yielding an excellent reforming effect.

In addition, the heating means are disposed inside the micro-channel to heat the inner space of the micro-channel with at least three exposed surfaces thereof, significantly enhancing heat efficiency, thereby allowing the reformer to operate with low power.

Moreover, it is possible to machine the first and second substrate via a semiconductor process, e.g. Microelectromechanical systems (MEMS), allowing mass production at low costs.

Alternatively, the first substrate can be made of PDMS, which enhances durability and thermal stability while simplifying the manufacturing processes at low costs.

Therefore, with application of MEMS, the reforming section and the carbon monoxide removing section can be disposed alongside while the output density of hydrogen gas can be significantly increased.

The present invention as set forth above is exemplified by a specific embodiment, but the invention may be embodied in many different forms and should not be construed as limited to the embodiments set forth herein. While the present invention has been shown and described in connection with the preferred embodiments, it will be apparent to those skilled in the art that modifications and variations can be made without departing from the spirit and scope of the invention as defined by the appended claims.

1-6. (canceled)

7. A manufacturing method of a micro-reformer for producing hydrogen gas from a liquid fuel comprising steps of:
providing a first substrate having a first grooved path on one side thereof and a catalyst layer formed in an inner surface of the first grooved path;
providing a second substrate having a second grooved path and a catalyst layer corresponding to the first grooved path and the catalyst layer and a heating means; and
bonding the first and second substrates such that the first and second grooved paths are overlapped on each other to form a micro-channel, a reforming section adjacent to a fuel inlet, a carbon monoxide removing section downstream of the fuel inlet, and a hydrogen outlet downstream of the carbon monoxide removing section.

8. The method according to claim 7, wherein the step of providing a second substrate comprises depositing a Pt electrode on an exposed SiO₂ surface of opposed peripheries across the second grooved path to form heating means.

9. The method according to claim 7, wherein the step of providing a second substrate comprises depositing a SiO₂ layer on the electrode surface of the heating means and the inner surface of the grooved path.

10. The method according to claim 7, wherein the first substrate is made of silicon wafer material or poly-dimethysiloxane.

11. The method according to claim 10, wherein the step of forming the first substrate with PDMS comprises:
depositing SiO₂ on a Si wafer via thermal oxidation;
forming photo-resist on one surface of the Si wafer and performing photolithography on the photo-resist except the portion corresponding to the first grooved path;
pouring PDMS on the Si wafer and separating the cured PDMS layer from the Si wafer; and
surface-treating the inner surface of the first grooved path and coating a catalyst layer on the surface-treated inner surface of the first grooved path.
